(19) United States
(12) Patent Application Publication
(10) Pub. No.: US 2011/0240812 A1
(43) Pub. Date: Oct. 6, 2011

(54) UTILITY BRACKET

(75) Inventor: Josh Simons, Phoenix, AZ (US)

(73) Assignee: TRANSUNION CAPITAL CORPORATION, Phoenix, AZ (US)

(21) Appl. No.: 13/079,696

(22) Filed: Apr. 4, 2011

Related U.S. Application Data
(60) Provisional application No. 61/320,656, filed on Apr. 2, 2010.

(51) Int. Cl. G03B 17/00; F16M 13/00; F16M 13/02; B23P 17/04

(52) U.S. Cl. 248/222.14; 248/314; 248/205.1; 29/428

(57) ABSTRACT

A utility bracket used for the simplified attachment of accessories and equipment to photography/video support systems.

### CROSS-REFERENCE TO RELATED APPLICATIONS

This application is the non provisional application of, and claims priority to, U.S. Provisional Application Ser. No. 61/320,656 filed on Apr. 2, 2010, and entitled “IMPROVED BRACKET.” All of which is incorporated herein by reference in its entirety.

### FIELD OF INVENTION

Brackets used for the simplified attachment of accessories and equipment to photography/video support systems.

### BACKGROUND OF THE INVENTION

In the photography, video and/or lighting industry, craftsmen use a variety of equipment with a variety of commercial attachment mechanisms. Prior brackets are essentially limited to one attachment or require the use of an adaptor to convert the attachment to accept different sizes. A great deal of time and energy is put into changing out various adapters and attachment mechanisms, when exchanging or setting up accessories and equipment. As such, the industry would be enormously benefited by a bracket that simplifies the setup process.

### SUMMARY OF THE INVENTION

In general, the system is used to simplify the setup and attachment of accessories to a video/photography support system by utilizing a bracket, wherein the bracket includes a top surface with a plurality of holes for attaching a table, bracket and/or accessory. The bracket may also have a bottom surface having a plurality of different equipment (e.g., commercial equipment) fastener features. The plurality of different commercial equipment fastener features may include, for example, a first feature which is a ¼ inch-20 threaded hole configured to receive a standard tripod head, a second feature which is a ⅜ inch-16 threaded hole configured to receive a standard tripod mount, a third feature which is a ⅝ non threaded hole configured to receive a standard stud, and a fourth feature which is an arca-style mount. The first feature, the second feature, and the third feature may be located along a centerline of the bottom surface. The bracket may also have a body portion extending between the top surface and the bottom surface. In various embodiments, a table may be mated to the top surface of the bracket. Also in various embodiments, the bracket may attach to a stand, with one of the plurality of different commercial equipment fastener features attaching to a corresponding feature on the stand.

### BRIEF DESCRIPTION OF THE DRAWINGS

A more complete understanding may be derived by referring to the detailed description and claims when considered in connection with the figures, wherein like reference numbers refer to similar elements throughout the figures, and:

FIG. 1A is an exemplary embodiment of a perspective view of a utility bracket;

FIG. 1B is an exemplary embodiment of a perspective view of a utility bracket with arca-style feature;

FIG. 2 is an exemplary embodiment of a bottom view of a utility bracket;

FIG. 3A is an exemplary embodiment of a top view of a utility bracket with three mounting features;

FIG. 3B is an exemplary embodiment of a side cross section view of a utility bracket;

FIG. 3C is an exemplary embodiment of a bottom view of a utility bracket with three commercial equipment fastener features;

FIG. 4A is an exemplary embodiment of a top view of a utility bracket with four mounting features;

FIG. 4B is an exemplary embodiment of a side view showing hidden lines of a utility bracket;

FIG. 4C is an exemplary embodiment of a bottom view of a utility bracket with arca-style connector;

FIG. 4D is an exemplary embodiment of a side view of a utility bracket rotated 90 degrees compared to FIG. 4B;

FIG. 5 is an exemplary embodiment of a bracket supporting a table with a keyboard and mouse on a photography light fixture;

FIG. 6 is an exemplary embodiment of a of a bracket supporting a table with a computer on a tripod;

FIG. 7 is an exemplary embodiment of a of a bracket supporting a table on a photography light fixture; and

FIG. 8 is an exemplary embodiment of a of a bracket supporting a tablet computer on a tripod.

### DETAILED DESCRIPTION

The detailed description of exemplary embodiments herein makes reference to the accompanying drawings, which show exemplary embodiments by way of illustration and its best mode. While these exemplary embodiments are described in sufficient detail to enable those skilled in the art to practice the invention, it should be understood that other embodiments may be realized and that logical, chemical and mechanical changes may be made without departing from the spirit and scope of the invention. Thus, the detailed description herein is presented for purposes of illustration only and not of limitation. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

The invention includes a device that facilitates mounting objects and/or accessories to standard photography support systems. Such accessories may include, for example, a table, computer (including laptops, notebooks, netbooks, tablets etc.), computer brackets, work bench, lights, cameras, anything related to photography, audio and/or video, or anything that somebody would want to have the versatility of mounting on a tripod head, tripod mount or studio light stand.

The device is configured to attach to more than one type and/or size of support such as any of a variety of commercial equipment fastener features. The device may comprise any type of material such as, for example, metal, plastic, wood, aluminum, glass, and/or any other material or any combination thereof. The device may comprise any configuration such as, for example, square, rectangular, circular and/or other geometric shape(s), or any combination thereof.

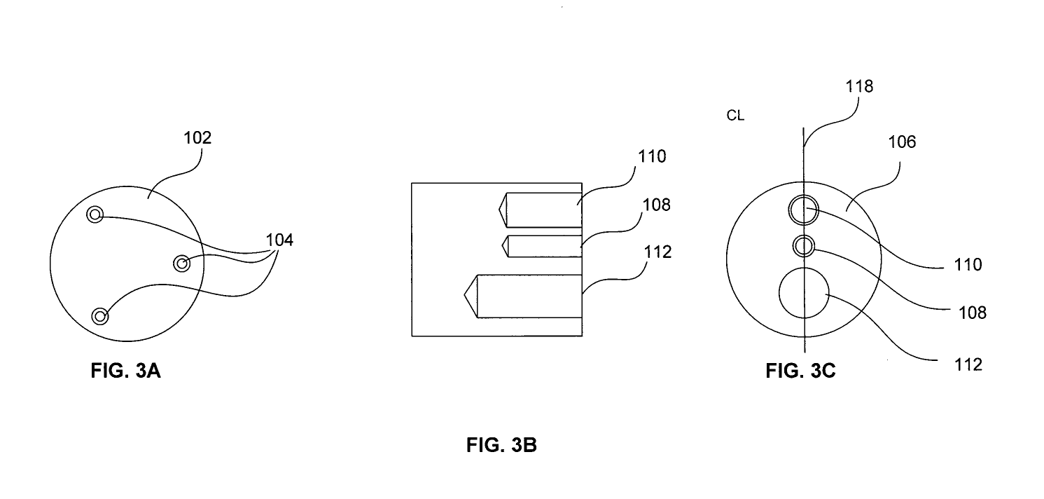

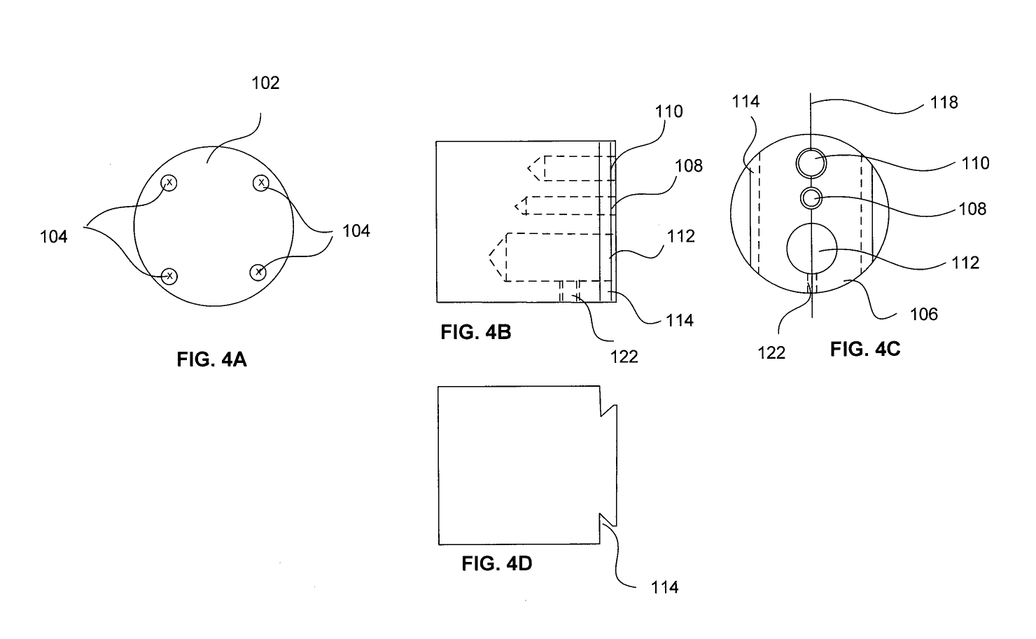

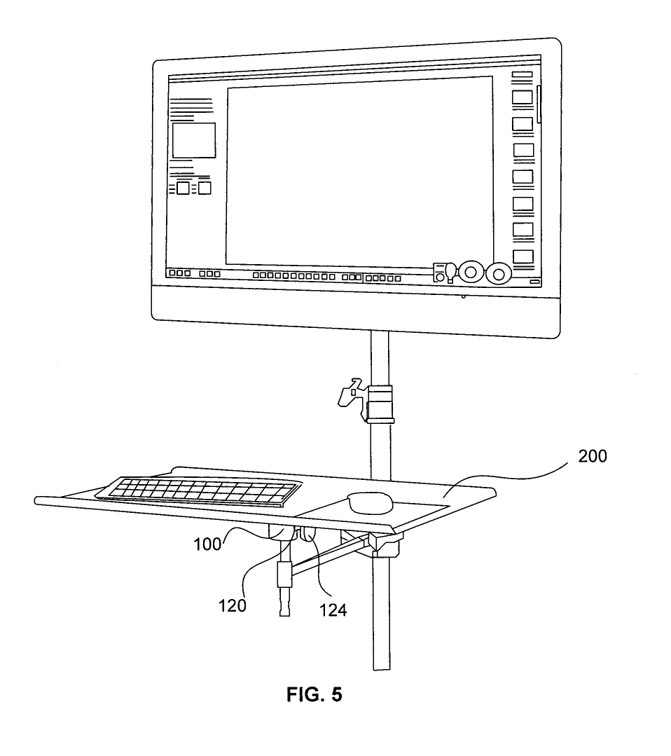

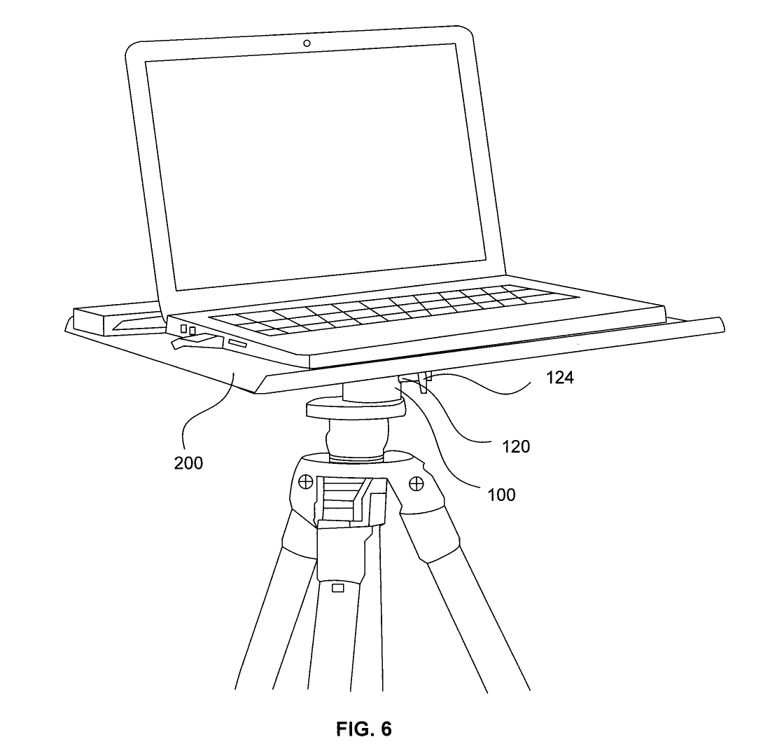

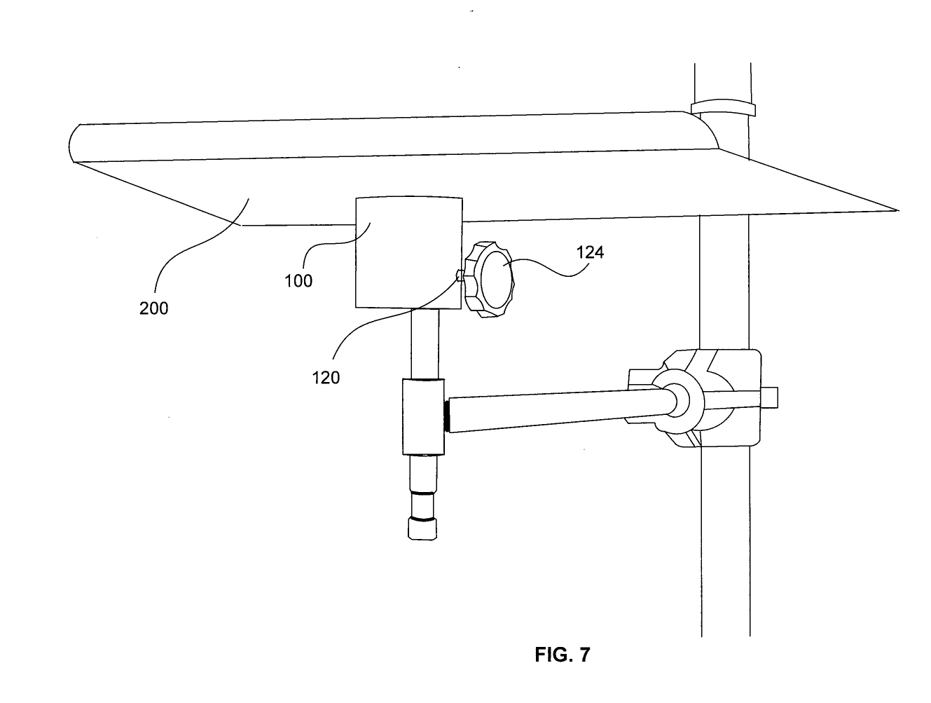

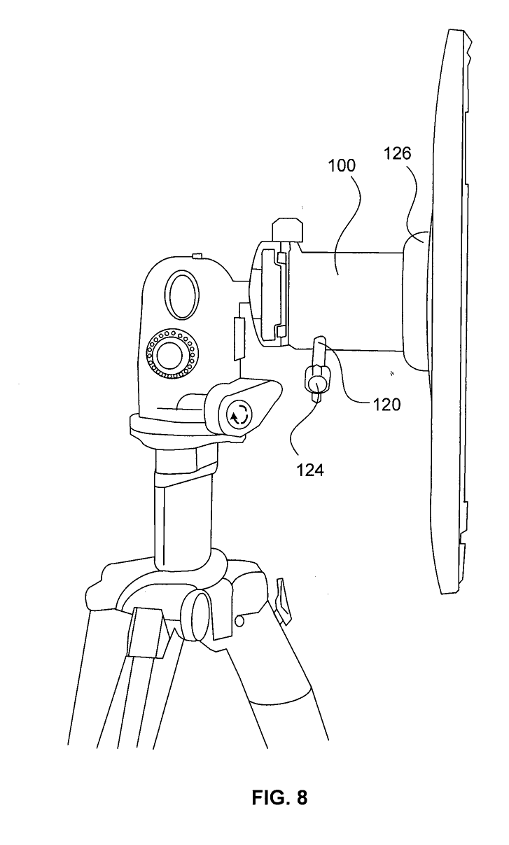

In accordance with one embodiment, referring to the FIG. 3A, an exemplary top surface 102 of a utility bracket 100 may have a plurality of holes 104 and or fasteners. FIG. 3A shows an embodiment with three mounting screws on the bracket which allow the variety of brackets or any item to be secured to the bracket below. Any number of fasteners may be used for mounting. For example, FIG. 4A illustrates four fasteners. A variety of brackets or accessories may be mounted to top surface 102 of bracket 100. For example, a table may be mounted to top surface 102. In other examples, brackets for computers, monitors, photography, video, and/or lighting may also be mounted to top surface 102. For example, FIGS. 5 and 7 illustrate bracket 100 attached to a light support system and supporting a table 200 which in turn supports a keyboard and mouse. The table may be a general purpose table capable of supporting computer equipment (e.g. desktop computers, laptops, tablets, monitors, printers, scanners, etc.) photography equipment, video equipment, lighting equipment, and the like. The table may also be used as a working platform for writing, sketching, note taking or similar tasks. In another example, FIG. 6 illustrates bracket 100 attached to a tripod and supporting a table 200 which in turn supports a laptop computer. In another example, FIG. 8 illustrates bracket 100 attached to an adapter attached to an arca-style mount (while it may also be noted that in various embodiments the bracket may be mounted directly to the arca-style mount) which is supported by a tripod. The bracket in FIG. 8 also mounts to a tablet bracket.

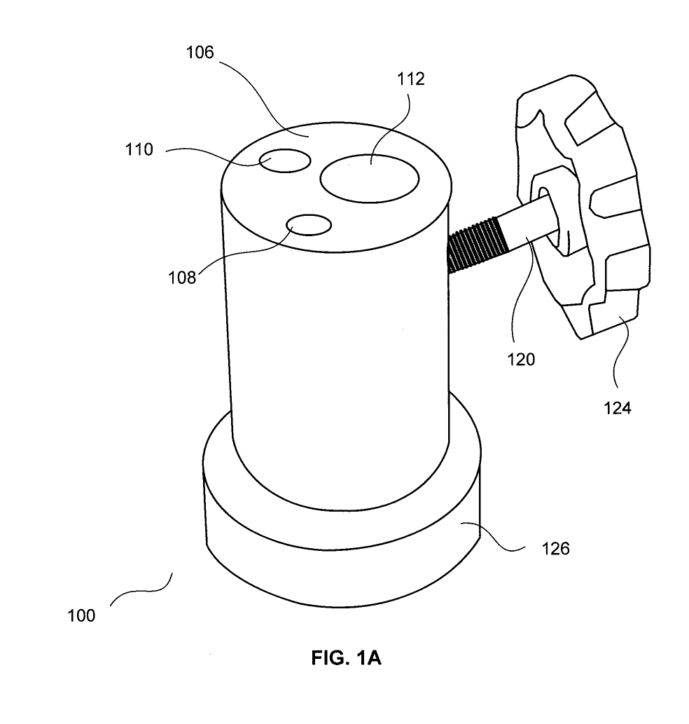

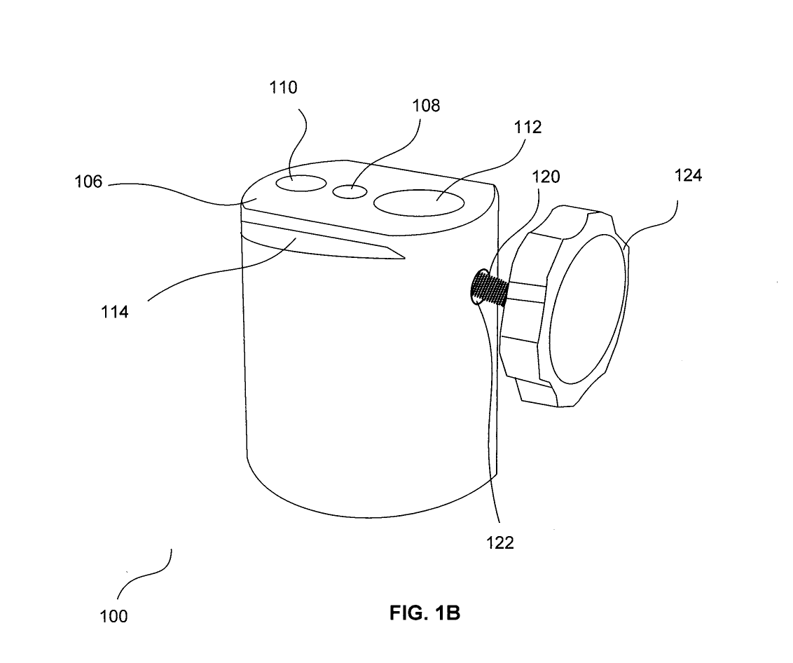

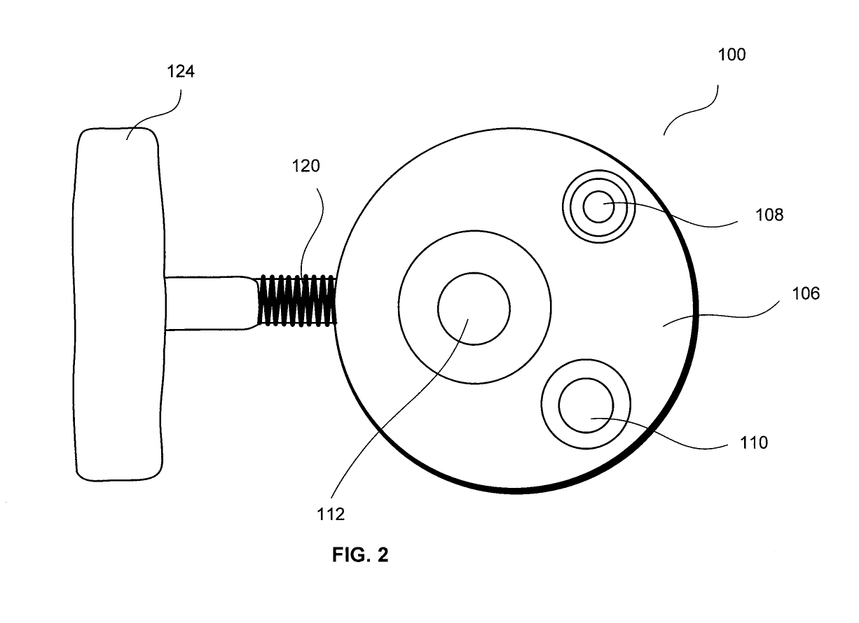

In accordance with one embodiment, referring to FIGS. 1 and 2, bracket 100 may include a bottom surface 106 having a variety of commercial equipment fastener features. In various examples bracket 100 may combine a plurality of commercial equipment fastener features into one bracket. These commercial equipment fastener features include standard sizes used by photographers and audio/video. Such sizes may include, for example, ¼ inch-20 threads (feature 108), ⅜ inch-16 threads (feature 110), ⅝ inch female (feature 112) for a ⅝″ stud, and an arca-style mount (feature 114) having a dove tail feature configured to receive a corresponding feature on the support system (an Arca-Swiss Mount is one example of an arca-style mount). Such sizes are all related, respectively, to a tripod head, tripod mount, a studio light stand, and alternative tripod mount.

An embodiment of the present bracket encompasses any combination of the equipment fastener features. While some features may be described as commercial equipment fasteners, the system contemplates and includes any type of fastener features including non-commercial fasteners. Referring to FIGS. 2B, 5B, 5C, and 5D all four of the commercial equipment fastener features may be incorporated into one product for ease of use and maximum versatility. While in certain embodiments, as illustrated in FIG. 1A and FIG. 2, features 108, 110, and 112 may be situated across the bottom surface 106 such that they do not interfere with one another. In other embodiments, referring to FIG. 1B features 108, 110, and 112 may be situated along a centerline 118 of the bottom surface 106 with feature 114 situated along either side of features 108, 110, and 112.

In accordance with one embodiment, referring to FIGS. 1-3 bracket 100 includes a hole 122 in the body portion. The hole allows a screw 120 with a first end of screw 120 passing through the body into the feature 112 hole. Screw 120 includes a second enlarged end 124 opposite the first end. The second large end may be a handle, knob, wing, etc. that allows for easy rotation of the screw. Screw 120 is configured to advance into feature 112 hole as the screw is rotated. As it advances it may create a force against any rod inserted into feature 112 securing the engagement.

In accordance with one embodiment, bracket 100 may have a body that is larger in diameter on an end 126 proximal to the top portion than on the opposing end. This larger diameter may provide additional support to any accessory mounted on the top portion of bracket 100.

In accordance with one embodiment, a method for mounting a computer on a variety of photography support systems including a tripod and a photography light rack comprises setting up the tripod and the photography light rack, mounting the utility bracket to the tripod using feature 108 or 110 and mounting a table on the top surface of the utility bracket. The utility bracket may be easily removed from the tripod (or any support system it is attached to) and placed on another support system without having to deal with adaptors or other complicated setup pieces. For example the bracket and table may be mounted on the photography light rack. The utility bracket may utilize feature 112 for attaching to the support rod/bars on the photography light rack. In one example, a computer may then be placed on the table allowing quick and easy access to beneficial software with an efficiency of time and parts in setting up the support system.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. Moreover, where a phrase similar to “at least one of A, B, or C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A bracket comprising:
a top surface having plurality of holes for retaining a mountable feature;
a bottom surface having a plurality of different commercial equipment fastener features; and
a body portion extending between the top surface and the bottom surface.

2. The bracket of claim 1, wherein the plurality of different commercial equipment fastener features includes at least one feature which is a ¼ inch-20 threaded hole configured to receive a standard tripod head.

3. The bracket of claim 1, wherein the plurality of different commercial equipment fastener features includes at least one feature which is a ⅜ inch-16 threaded hole which is configured to receive a standard tripod mount.

4. The bracket of claim 1, wherein the plurality of different commercial equipment fastener features includes at least one feature which is a ⅝ non-threaded hole configured to receive a standard stud.

5. The bracket of claim 1, wherein the plurality of different commercial equipment fastener features includes at lest one feature which is an arca-style mount.

6. The bracket of claim 1, wherein the mountable feature is at least one of a table, laptop bracket, a monitor bracket, and a tablet computer bracket.

7. The bracket of claim 1, wherein the body is larger in diameter on an end proximal to the top portion.

8. The bracket of claim 4, wherein the body includes a hole with a first end of a screw passing through the body into the ⅝ inch non-threaded hole, wherein the screw includes a second enlarged end opposite the first end, wherein the screw is configured to advance into the ⅝ inch non-threaded hole as the screw is rotated.

9. The bracket of claim 1, wherein the plurality of different commercial equipment fastener features includes a first feature which is a ¼ inch-20 threaded hole configured to receive a standard tripod head, a second feature which is a ⅜ inch-16 threaded hole configured to receive a standard tripod mount, a third feature which is a ⅝ non threaded hole configured to receive a standard stud, and a fourth feature which is an arca-style mount, wherein the first feature, the second feature, and the third feature are located along a centerline of the bottom surface.

10. An support system for used with photography equipment comprising:
a bracket including a top surface having plurality of holes for retaining a table;
a bottom surface having a plurality of different commercial equipment fastener features wherein the plurality of different commercial equipment fastener features includes a first feature which is a ¼ inch-20 threaded hole configured to receive a standard tripod head, a second feature which is a ⅜ inch-16 threaded hole configured to receive a standard tripod mount, a third feature which is a ⅝ non threaded hole configured to receive a standard stud, and a fourth feature which is an arca-style mount, wherein the first feature, the second feature, and the third feature are located along a centerline of the bottom surface;
a body portion extending between the top surface and the bottom surface;
a table mated to the top surface of the bracket; and
a stand, wherein one of the plurality of different commercial equipment fastener features attaches to a corresponding feature on the stand.

11. A method for mounting a computer on a variety of photography support systems including a tripod and a photography light rack comprises:
setting up the tripod and the photography light rack;
mounting a utility bracket to the tripod, wherein the utility bracket includes a feature for mounting to the tripod;
mounting a table on the utility bracket, wherein the utility bracket has a surface configured to mount a table;
removing the utility bracket from the tripod;
mounting the utility bracket on the photography light rack, wherein the utility bracket includes a feature for mounting to the ⅝ inch support bars on the photography light rack; and
setting a computer on the table.
